(19) United States
(12) Patent Application Publication
(10) Pub. No.: US 2015/0306557 A1
(43) Pub. Date: Oct. 29, 2015

(54) APPARATUS FOR THE PRODUCTION OF GAS

(71) Applicant: WORGAS BRUCIATORI S.R.L., Formigine (Modena) (IT)

(72) Inventors: GIULIO CENCI, FERRARA (IT); ERMANNO RIGHI, MODENA (IT); FABRIZIO SIBANI, CASALGRANDE (IT); ANDREA MARCHIONNI, AGLIANA (IT); JONATHAN FILIPPI, PRATO (IT); FRANCESCO VIZZA, FIRENZE (IT); CLAUDIO BIANCHINI, FIRENZE (IT); SABRINA MAGNANI, MARANELLO (IT)

(21) Appl. No.: 14/441,696

(22) PCT Filed: Jan. 24, 2013
(86) PCT No.: PCT/IT2013/000022

§ 371 Date: May 8, 2015

(51) Int. Cl. B01J 7/00; B01J 19/00

(52) U.S. Cl. CPC B01J 7/00; B01J 19/0033; B01J 2219/00164; B01J 2219/00182

(57) ABSTRACT

Apparatus for producing gas, comprising: a reactor (R) that holds a determined volume arranged to contain two or more reactants and at least one gas; a connection circuit (S), arranged to put the reactor (R) in communication with a user (U); a supply device (2), arranged to supply at least one reactant to the reactor (R); a control module (MC), connected to the supply device (2); a control valve (5), connected to the control module (MC), which is arranged to regulate, following a command, the supply of gas to the user (U); a first pressure detector (6), arranged to detect a first pressure (P1) of the gas upstream of the control valve (5), which is connected to the control module (MC) and sends the control module (MC) a first signal indicating the pressure (P1) detected; a second pressure detector (7), arranged to detect a second pressure (P2) of the gas downstream of the control valve (5), which is connected to the control module (MC) and sends the control module (MC) a second signal indicating the pressure (P2) detected.

The present invention relates to an apparatus for the production of gas.

The invention refers in particular to an apparatus comprising a reactor within which a reaction is developed between two or more reactants that produce a gas. The reactor is placed in communication with a user that receives the gas produced and uses it for the production of thermal or electrical energy or for other purposes.

A typical example of the use of devices of this kind is connected with the production of hydrogen. The hydrogen produced can be used to supply fuel cells, or for other purposes. The reactor is intended to contain two or more reactants which, when put in suitable conditions, produce a certain flow rate of hydrogen.

A critical aspect relative to the operation and management of the devices currently available is the control of the reaction that takes place within the reactor.

The control of the reaction is extremely important in the case of hydrogen production. In fact, the most efficient reactions envisage the use of particularly reactive reactants that can create difficulties in the control of the reaction and therefore the control of the quantity of gas produced.

In the devices currently available the control of the reaction is performed with different methods on the typical parameters of the reactors that produce gas. Typically: the pressure, the quantity of gas produced and relatively the pressure and flow rate. The values acquired are processed through a control module that manages the influx of reactants so as to modify the reaction itself.

The devices currently available are not completely satisfactory from the point of view of the control of the reaction that produces the gas required by the user. In particular, the devices for producing hydrogen could be decidedly improved in terms of the control of the reaction that produces the required hydrogen due to the kinetics of the reaction conditioned by the extreme reactivity of the reactants.

Reactions for producing hydrogen are, in fact, rather inconsistent, i.e., under the same conditions, they can produce different quantities of gas in the same unit of time. In devices of the known type, it is substantially impossible to instantaneously regulate the quantity of gas produced in the reaction, according to its use, since it is attempted to regulate the kinetics of the reaction by varying the intake of at least one reactant. This type of control, for the reaction instability reasons already mentioned, is not very effective. Hence, it is often necessary to adopt storage tanks so as to compensate for the excessive production of gas at times of low usage of the gas itself.

The aim of the present invention is to offer an apparatus for producing gas that allows the performance of the devices currently available to be improved.

An advantage of the device according to the present invention is that it allows the production of gas to be regulated instantaneously, according to the requirements of a user.

Another advantage of the device according to the present invention is that it does not require the adoption of storage tanks for the gas produced.

Further characteristics and advantages of the present invention will become clear from the following detailed description of an embodiment of the invention in question, illustrated by way of non-limiting example in the attached FIGURE wherein:

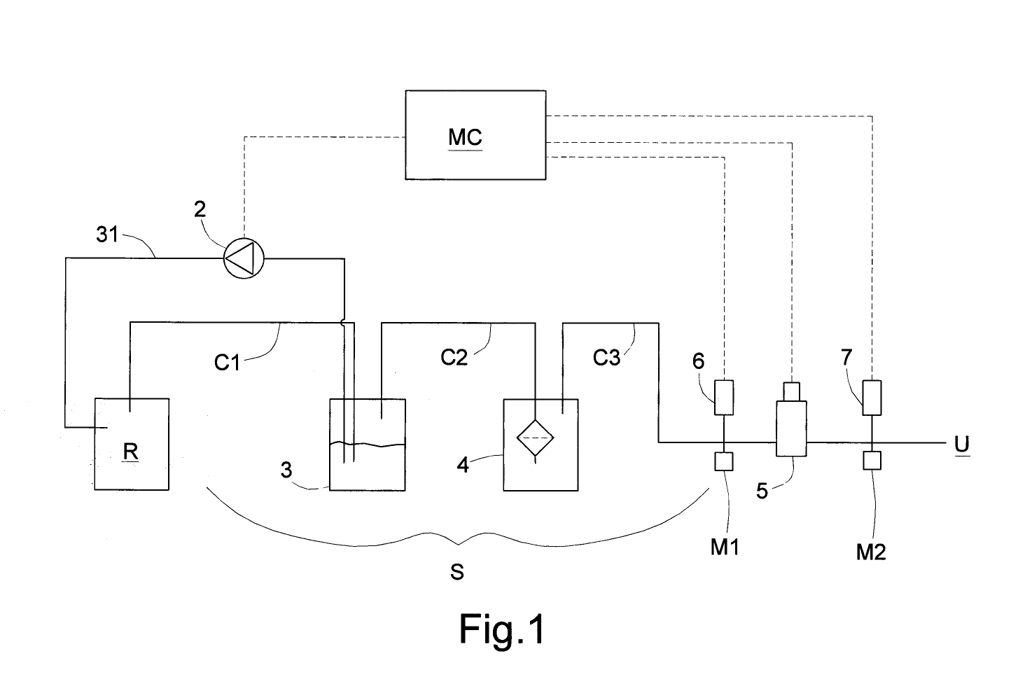

FIG. 1 shows a diagram that represents an embodiment of the device according to the present invention.

As already mentioned in the introductory part of the description, the apparatus for producing gas according to the present invention is particularly suitable for the controlled production of hydrogen. The hydrogen produced can be used in a fuel cell, as a fuel for supplying a burner, for storage, for laboratory uses, or for another use. This does not exclude the fact that the apparatus is also perfectly suitable for producing other gases, using other reactants and activators.

The apparatus comprises a reactor (R) which holds a determined volume arranged to contain two or more reactants and one or more gases produced by a reaction between the reactants.

In the preferred use of the apparatus, the gas produced is hydrogen. The reactants can be for example aluminium and caustic soda which, with the addition of water, produce hydrogen according to the following reaction:

2Al+2NaOH+6H2O→2NaAl(OH)4+3H₂.

Another example of a reaction for producing hydrogen involves sodium borohydride which reacts with water according to the following reaction:

NaBH₄+2H₂O→NaBO2+4H₂.

Advantageously caustic soda and aluminium, or sodium borohydride in the second example, can be provided in solid form or in solution within the reactor (R). To trigger the reaction it is sufficient to introduce water into the reactor (R) so that it comes into contact with the other reactants.

The apparatus further comprises a connection circuit (S) arranged to put the reactor (R) in communication with a user (U). In the preferred use of the apparatus, the user (U) is a fuel cell.

A supply device (2) is arranged to supply at least one reactant to the reactor (R). In the preferred use of the apparatus according to the present invention, the reactant supplied through the supply device (2) is water. The supply device (2) preferably comprises a pump. The use of a pump allows the flow rate of water introduced into the reactor (R) to be precisely regulated. Since the reaction between water and the reactants, caustic soda and aluminium or sodium borohydride, is rather intense, the possibility to dose the water by means of the pump allows the reaction, and the consequent production of hydrogen, to be controlled very precisely.

The apparatus further comprises a control module (MC), connected to the supply device (2) to control its operation.

A control valve (5) is arranged to regulate the flow rate of gas sent to the user (U). The control valve (5), in a first embodiment, is an on-off valve and is arranged to act as a pressure regulator through high frequency closing and opening. The control module (MC) regulates the frequency of the opening and closing cycles of the control valve (5) so as to regulate the flow rate of gas in a substantially continuous way. In a preferred embodiment of the device, the control valve is substantially arranged in a section of the connection circuit (S) situated immediately upstream of the section of connection to the user (U).

The apparatus also comprises a first pressure detector (6), arranged to detect a first pressure (P1) of the gas upstream of the control valve (5). The first pressure detector (6) is connected to the control module (MC) and sends the control module (MC) a first signal indicating the pressure (P1) detected upstream of the control valve (5).

A second pressure detector (7) is arranged to detect a second pressure (P2) of the gas downstream of the control valve (5). The second pressure detector (7) is connected to the control module (MC) and sends the control module (MC) a second signal indicating the pressure (P2) detected downstream of the control valve (5).

Upstream and downstream of the control valve (5) two safety valves (M1,M2) are also located, arranged to intervene and free an outlet vent for the gas should the pressure exceed a safe value.

The control module (MC) is arranged to compare the first pressure (P1) with a first threshold value (P1max) and, if the first pressure (P1) is higher than the first threshold value (P1max), to send the supply device (2) a command to reduce or stop the intake of at least one reactant to the reactor (R). Vice versa, if the first pressure (P1) is lower than the first threshold value (P1max), the control module (MC) is arranged to send the supply device (2) a command to increase the intake of at least one reactant to the reactor (R). In the preferred use of the apparatus, the increase or decrease in the production of hydrogen is obtained by increasing or decreasing the flow rate of water sent to the reactor (R).

The control module (MC) is further arranged to compare the second pressure (P2) with a second threshold value (P2max) and, if the second pressure (P2) is higher than the second threshold value (P2max), to send the control valve (5) a command to reduce the gas flow rate. Vice versa, if the second pressure (P2) is lower than the second threshold value (P2max), the control module (MC) is arranged to send the control valve (5) a command to increase the gas flow rate.

In an alternative embodiment of the device, as well as making comparisons between the first pressure (P1) and the first threshold value (P1max) and between the second pressure (P2) and the second threshold value (P2max), the control module (MC) is arranged to detect the variation over time of the first pressure (P1) and the second pressure (P2). In substance, the control module (MC) detects the signal sent by the first pressure detector (6) at pre-established time intervals. If the first pressure (P1) increases over time, the control module (MC) sends the supply device (2) a command to decrease the intake of reactants. Vice versa, if the first pressure (P1) decreases over time, the control module (MC) sends the supply device (2) a signal to increase the intake of reactants. In the same way, the control module (MC) detects the signal sent by the second pressure detector (7) at pre-established time intervals. If the second pressure (P2) increases over time, the control module (MC) sends the control valve (5) a signal to reduce gas flow rate. If the second pressure (P2) decreases over time, the control module sends the control valve (5) a signal to increase the gas flow rate. This control envisages a management program within the control module (MC), which interacts with the influx of the reactants within the reactor so that the first pressure (P1), being a function of the reaction and the intake of reactants, remains as stable as possible close to and below the first threshold value (P1max) according to the variation of the second pressure (P2), which, in turn, depends on the quantity of gas required by the user (U).

The interventions of the control module (MC) on the control valve (5) are coherent with the load required of the user (U). If the load to which the user (U) is subject is reduced, the consumption of gas is reduced and, consequently, the second pressure (P2) increases. In that case the control module (MC) commands the flow rate reduction of the control valve (5). Vice versa, if the load to which the user (U) is subject increases, the consumption of gas increases and, consequently, the second pressure (P2) decreases. In this second case the control module (MC) commands the increase in flow rate of the control valve (5).

Simultaneously, the control module (MC) performs the control of the first pressure (P1), which varies according to the second pressure (P2) and, consequently, the regulation conditions of the control valve (5). With particular reference to the condition wherein the control valve (5) is in the flow rate increase step, please note that if the second pressure (P2) drops, the first pressure (P1) also drops as a result and the control module (MC) commands the supply device (2) to increase the intake of reactants. Vice versa, in conditions wherein the valve (5) is in the flow rate reduction step, the second pressure (P2) drops and the first pressure (P1) rises and the control module (MC) commands the supply device (2) to reduce the intake of reactants.

Preferably the control module (MC) is arranged to send the supply device (2) a command signal proportional to the variation of the first pressure (P1) over time. The supply device (2) is arranged to regulate the intake of at least one reactant in proportion to the command signal received. In other words, the higher the variation of the pressure (P1) over time, the higher the variation of the intake of at least one reactant to the reactor (R).

Preferably the apparatus comprises a vapour separator (3), arranged in communication with the reactor (R) so as to remove vapour and/or liquid from the gases produced in the reactor (R). The separator (3), in FIG. 1, is located upstream of the control valve (5), but could also be located downstream of the control valve (5) and upstream of the user. The presence of a vapour separator (3) is particularly advantageous in the preferred use of the apparatus, since the most efficient reactions for the production of hydrogen produce remarkable quantities of water vapour. The water vapour is condensed in the form of water in the vapour separator (3). Advantageously the apparatus comprises a recirculation conduit (31) which connects the vapour separator (3) to the reactor (R), to send the reactor (R) a flow rate of liquid accumulated in the separator (3) itself. In the preferred use of the apparatus, the water accumulated in the vapour separator (3) can be sent to the reactor (R) through the recirculation conduit (31) to act as one of the reactants. The supply device (2), preferably a pump, is arranged along the recirculation conduit (31) itself.

The reactions underway within the reactor (R) are highly exothermic and ensure that in devices that do not use recirculation, during the operation of the device a higher quantity of water is consumed than that determined by the stoichiometry of the reaction, therefore the presence of the recirculation conduit (31) remarkably reduces the need for an external intake of water.

Preferably the apparatus further comprises a filter (4), arranged in communication with the reactor (R) so as to remove particles and/or unwanted products from the gas produced in the reactor (R). In FIG. 1, the filter (4) is located upstream of the control valve (5), but could also be located downstream of the valve itself and upstream of the user. In both cases the filter (4) is preferably arranged downstream of the separator (3). Both the filter (4) and the separator (3) jointly contribute both to the functionality of the production of gases and to their quality.

In the preferred embodiment of the apparatus, the separator (3), the filter (4) and the control valve (5), along with a first conduit (C1) which connects the reactor (R) to the separator (3), a second conduit (C2) which connects the separator (3) to the filter (4) and a third conduit (C3) which connects the filter (4) to the control valve (5), define as a whole the connection circuit (S) that puts the reactor (R) in communication with the user (U). As a whole, the connection circuit (S) is structured so that the pressure is the same in every section. In particular, the separator (3) and the filter (4) are structured and are connected to each other and to the reactor (R) in order to be able to operate as pressure accumulators. In other words, the gas produced in the reactor (R) can accumulate in the separator (3) and in the filter (4) which are sized so as to be able to contain a determined volume of gas. This makes it possible to accumulate a determined quantity of gas produced and, consequently, to stabilise the first pressure (P1) reducing pressure peaks due to fluctuations in the generation of the gases typical of the reaction, and to delay the intervention of the control module (MC) so as to reduce the intake of at least one reactant should the apparatus be in the condition wherein the second pressure (P2) is higher than the second threshold value (P2max) or the second pressure (P2) is in the reduction step and the control valve (5) is, therefore, in the flow rate reduction configuration. In substance, if the second pressure (P2) is in the reduction step or is higher than the second threshold value (P2max), the control module (MC) intervenes initially commanding the reduction of the flow rate of the control valve (5). Following the reduction of the flow rate of the control valve (5), the production of gases in the reactor (R) proceeds without variations and the gas produced accumulates in the reactor (R) and in the connection circuit (S), including the separator (3) and the filter (4), and the first pressure (P1) increases. As the first pressure increases (P1) the control module (MC) commands the supply device (2) to decrease the intake of at least one reactant to the reactor (R). In the preferred use of the apparatus, the control module (MC) commands a reduction in the flow rate of water sent by the pump (2) to the reactor (R) through the recirculation conduit (31). If the second pressure (P2) decreases, because the consumption of gas by the user increases, the control module (MC) commands the increase in flow rate through the control valve (5) so as to cause an increase in the second pressure (P2) through the control valve (5). Consequently, the first pressure (P1) starts to drop. As the first pressure (P1) drops, the control module (MC) sends the supply device (2), the pump, a signal to increase the intake of water to the reactor (R).

1. Apparatus for the production of gas, comprising:
a reactor (R) that holds a determined volume arranged to contain two or more reactants and at least one gas;
a connection circuit (S), arranged to put the reactor (R) in communication with a user (U); a supply device (2), arranged to supply at least one reactant to the reactor (R);
a control module (MC), connected to the supply device (2);
comprising:
a control valve (5), connected to the control module (MC), which is arranged to regulate, following a command, the supply of gas to the user (U);
a first pressure detector (6), arranged to detect a first pressure (P1) of the gas upstream of the control valve (5), which is connected to the control module (MC) and sends the control module (MC) a first signal indicating the pressure (P1) detected;
a second pressure detector (7), arranged to detect a second pressure (P2) of the gas downstream of the control valve (5), which is connected to the control module (MC) and sends the control module (MC) a second signal indicating the pressure (P2) detected; the control module (MC) is arranged to detect the variation over time of the first pressure (P1) and the second pressure (P2), and to act as follows:
if the first pressure (P1) increases over time, the control module (MC) sends the supply device (2) a command to reduce the intake of reactants; if the pressure (P1) decreases over time, the control module (MC) sends the supply device (2) a signal to increase the intake of reactants;
if the second pressure (P2) increases over time, the control module (MC) sends the control valve (5) a signal to reduce the gas flow rate; if the second pressure (P2) decreases over time, the control module sends the control valve (5) a signal to increase the gas flow rate.

2. Apparatus according to claim 1, wherein the control module (MC) is arranged to send the supply device (2) a command signal proportional to the variation of the first pressure (P1) and the second pressure (P2) over time and the supply device (2) is arranged to regulate the intake of at least one reactant in proportion to the command signal received.

3. Apparatus according to claim 1, wherein the control module (MC) is arranged to compare the first pressure (P1) with a first threshold value (P1max) and, if the first pressure (P1) is higher than the first threshold value (P1max), to send the supply device (2) a command to reduce the intake of at least one reactant to the reactor (R); vice versa, if the first pressure (P1) is lower than the first threshold value (P1max), the control module (MC) is arranged to send the supply device (2) a command to increase the intake of at least one reactant to the reactor (R).

4. Apparatus according to claim 1, wherein the control module (MC) is arranged to compare the second pressure (P2) with a second threshold value (P2max) and, if the second pressure (P2) is higher than the first threshold value (P2max), to send the control valve (5) a command to reduce the flow rate; vice versa, if the second pressure (P2) is lower than the second threshold value (P2max), the control module (MC) is arranged to send the control valve (5) a command to increase the flow rate.

5. Apparatus according to claim 1, comprising a vapour separator (3), arranged in communication with the reactor (R) so as to remove vapour and/or liquid from the gas produced in the reactor (R).

6. Apparatus according to claim 5, comprising a recirculation conduit (31) which connects the vapour separator (3) to the reactor (R), to send the reactor (R) a flow rate of liquid accumulated in the separator (3) itself.

7. Apparatus according to claim 1, wherein the supply device (2) is a pump.

8. Apparatus according to claim 6, wherein the supply device (2) is a pump arranged along the recirculation conduit (31).

9. Apparatus according to claim 1, comprising a filter (4), arranged in communication with the reactor (R) so as to remove particles and/or unwanted products from the gas produced in the reactor (R).

10. Apparatus according to claim 5, wherein the separator (3) and the filter (4) are structured and are connected to each other and to the reactor (R) in order to be able to operate as pressure accumulators.

11. Apparatus for producing gas, comprising:
a reactor (R) that holds a determined volume, arranged to contain two or more reactants and at least one gas;
a vapour separator (3), arranged in communication with the reactor (R) so as to remove vapour and/or liquid from the gas produced in the reactor (R);
a recirculation conduit (31) which connects the vapour separator (3) to the reactor (R), to send the reactor (R) a flow rate of liquid accumulated in the separator (3) itself; a supply device (2), comprising a pump, arranged along the recirculation conduit (31); a filter (4), arranged in communication with the vapour separator (3) so as to remove particles and/or unwanted products from the gas produced in the reactor (R);
a control valve (5), arranged to regulate, following a command, the supply of gas to the user (U);
a control module (MC), connected to the supply device (2) and to the control valve 5;
a first pressure detector (6), arranged to detect a first pressure (P1) of the gas upstream of the control valve (5), which is connected to the control module (MC) and sends the control module (MC) a first signal indicating the pressure (P1) detected;
a second pressure detector (7), arranged to detect a second pressure (P2) of the gas downstream of the control valve (5), which is connected to the control module (MC) and sends the control module (MC) a second signal indicating the pressure (P2) detected; the control module (MC) is arranged to detect the variation over time of the first pressure (P1) and the second pressure (P2), and to act as follows:
if the first pressure (P1) increases over time, the control module (MC) sends the supply device (2) a command to reduce the intake of at least one of the reactants; if the pressure (P1) decreases over time, the control module (MC) sends the supply device (2) a signal to increase the intake of at least one of the reactants;
if the second pressure (P2) increases over time, the control module (MC) sends the control valve (5) a signal to reduce the gas flow rate; if the second pressure (P2) decreases over time, the control module sends the control valve (5) a signal to increase the gas flow rate.

12. Apparatus according to claim 10, comprising a filter (4), arranged in communication with the reactor (R) so as to remove particles and/or unwanted products from the gas produced in the reactor (R).
